(19) United States
(12) Patent Application Publication
(10) Pub. No.: US 2018/0324001 A1
(43) Pub. Date: Nov. 8, 2018

(54) REAL-TIME DISTRIBUTED ENGINE FRAMEWORK OF ETHERNET VIRTUAL CONNECTIONS

(71) Applicant: CENTRE FOR DEVELOPMENT OF TELEMATICS, New Delhi (IN)

(72) Inventors: Vipin TYAGI, New Delhi (IN); Shishir SHROTRIYA, New Delhi (IN); Prashant CHUGH, New Delhi (IN); Deepika NAGPAL, New Delhi (IN); Hemant Kumar Singh CHAUHAN, New Delhi (IN)

(21) Appl. No.: 15/771,221

(22) PCT Filed: Apr. 8, 2016
(86) PCT No.: PCT/IN2016/000091

§ 371 Date: Apr. 27, 2018

(30) Foreign Application Priority Data
Oct. 27, 2015 (IN) 3482/DEL/2015

(51) Int. Cl. H04L 12/46; H04L 12/26

(52) U.S. Cl. CPC H04L 12/4645; H04L 43/087; H04L 45/66; H04L 43/0835; H04L 43/0858

(57) ABSTRACT

The present invention disclosure relates to a system for monitoring deterministic characteristics of a safety critical network. The system has an Ethernet switch associated to a processor-memory unit that runs deterministic unit functionality or a multi-core system in which one or more cores have Ethernet switch functionality and one or more dedicated cores have deterministic unit functionality, a communication channel between the Ethernet switch and the processor-memory unit associated to a deterministic unit or the inter-core communication channel between the core/s running Ethernet switch functionality and the core/s running deterministic unit functionality and an Ethernet virtual connection (EVC) between adjacent switches through which the associated deterministic units communicate with each other.

### FIELD OF THE DISCLOSURE

The field of the present disclosure pertains to a real-time, distributed engine framework and particularly, to a real-time, distributed, deterministic unit framework for Ethernet virtual connections used in safety critical networks.

### BACKGROUND

Many safety critical industrial automation and control networking applications are available today which have stringent requirements in terms of reliability and determinism. These requirements are defined quantitatively in terms of various parameters such as latency, jitter, bit error rate or packet error rate, packet loss and more. These parameters are measured end-to-end across various switches in the network architecture designed for a particular safety critical network. Network architects of such safety critical applications intend to use Ethernet as networking technology in their networking solution.

Ethernet as a widely used LAN technology has various standards that are predominantly defined by IEEE and Metro Ethernet Forum. These standards have been continuously evolving over many years. However, standards for deterministic Ethernet technology which can be used in safety critical networking applications are still under development.

In the absence of standards which can ensure that the reliability and determinism requirements are met, the network architects follow a set of best practices. These set of best practices include the following: firstly, the network design using network engineering techniques available in the latest Ethernet standards that help reduce latency for the latency-sensitive traffic. These techniques include: traffic shaping at Source End Equipment, traffic policing at ingress of all intermediate Network Equipment, traffic shaping at egress of all intermediate Network Equipment, dedicated end-to-end connections with bandwidth parameters of these connections pre-configured as per the expected traffic rate, VLANs, QoS based on IEEE802.1p based priority levels and Diffserv, disabling MAC learning to reduce time.

Another best practice is to select a network topology that has less number of hops between end stations so as to reduce propagation latency across links as well as the queuing and processing latency. Another best practice is to check packet validation so that packets with errors are dropped before they reach the destination end equipment.

Yet another best practice includes doing packet transmission via mutually exclusive and independent paths from source equipment to end equipment to guard against packet drops and packet losses. This approach of parallel mutually-independent redundant paths and selection of the valid packet that is received first at the receiver in order to ensure dual goals of meeting latency bounds and packet error checks are met is suggested in IEC standard 62439-3 for two redundant paths and can as well be extended to three or more redundant paths depending upon reliability requirements.

Yet another practice is theoretically analyzing the network using techniques such as network calculus or latency calculus, so as to theoretically compute the upper bounds of latency, jitter etc. and re-design the network in case the results of theoretical analysis mandate the same. Further, in the existing art, simulating the network using network simulator tools to get an additional assurance that the planned objectives of determinism and reliability are met and redesigning the network if simulation results mandate the same, is another practice.

In one of the U.S. Pat. No. 7,012,893, the parameters such as latency and jitter are measured between sending node and receiving node to determine optimum packet size and optimum inter-packet interval for transmission of packet data between the sending node and the receiving node. This document further indicates that bandwidth allocations are adjusted upwards, if measurements indicate that the anticipated maximum packet loss will be exceeded. However, this patent lacks establishment of Ethernet virtual connections and lacks two levels of thresholds: an inner threshold for detection and an outer threshold before which controlling action is to be completed. Besides, this patent requires Corrective action to be taken only on the basis of latency and jitter measurement. It lacks measurement of packet errors and packet losses.

In order to overcome at least the above drawbacks, there arises a requirement of taking corrective actions to control reliability in such an environment.

### SUMMARY

The primary objective of the invention disclosure is to create a system that monitors deterministic characteristics of safety-critical systems in real-time and takes corrective action to ensure and control that deterministic characteristics are met at all times of network operations.

In order to meet the aforesaid objective, a real-time, deterministic unit is disclosed. This unit adds up capability of on-line measurement of determinism and reliability parameters of Ethernet virtual connections (EVCs) and taking continuous corrective actions until the objectives of determinism and reliability for the EVCs to be controlled are met. Thus, it gives an additional assurance of determinism and reliability over the best practices available in the prior art.

In an embodiment of the present invention disclosure, a method for monitoring deterministic characteristics of a safety critical network is disclosed. A plurality of parameters are determined on an Ethernet virtual connection (EVC), and the parameters that exceed an inner threshold are detected. The outcome of detected parameters is communicated to an associated deterministic unit such that the specific parameter is controlled.

According to an embodiment of the invention disclosure, the plurality of parameters comprise at least end-to-end latency, Latency of each hop, end-to-end Jitter, Jitter of each hop, End-to-end Frame error rate, Frame error rate of each hop, End-to-end Frame loss rate, Frame loss rate of each hop, Latency at each layer of protocol stack in Sending end Station, Latency at each layer of protocol stack in Receiving end Station.

According to another embodiment of the invention disclosure, the inner threshold comprises an outcome exceeding which control is initiated.

According to another embodiment of the invention disclosure, the parameters of said EVC are determined by an Ethernet switch associated to the deterministic unit.

According to yet another embodiment of the invention disclosure, the step of detection comprises an outer threshold.

According to still another embodiment of the invention disclosure, the outer threshold comprises an outcome before which the control is completed.

According to an embodiment of the invention disclosure, a system for monitoring deterministic characteristics of a safety critical network is disclosed. An Ethernet switch is associated to a processor-memory unit. Further, a communication channel is established between the Ethernet switch and the processor-memory unit associated to it, which runs the deterministic unit functionality. An Ethernet virtual connection (EVC) is provided between adjacent switches through which the associated deterministic units communicate with each other.

According to yet another embodiment, the Ethernet switch is a router, or an Ethernet interface card of a sender end station, or an Ethernet interface card of a receiver end station.

According to another embodiment, the system may be a multi-core system where one or more cores perform functions of Ethernet switch and there are one or more dedicated cores which run the deterministic unit logic. In such a scenario, communication between the core/s having the function of Ethernet Switch and the core/s having the function of deterministic unit, is through inter-core communication mechanism.

### BRIEF DESCRIPTION OF FIGURES

The detailed description is described with reference to the accompanying figures. In the figures, the left-most digit(s) of a reference number identifies the figure in which the reference number first appears. The same numbers are used throughout the drawings to reference like features and components.

FIG. 1 illustrates a prior art block diagram of the system according to an embodiment of the present disclosure.

FIG. 2 illustrates a block diagram of the present system according to an embodiment of the present disclosure.

### DETAILED DESCRIPTION

The following discussion provides a brief, general description of a suitable computing environment in which various embodiments of the present disclosure can be implemented. The aspects and embodiments are described in the general context of computer executable mechanisms. The embodiments described herein can be practiced with other system configurations, including Internet appliances, hand held devices, multi-processor systems, microprocessor based or programmable consumer electronics, network PCs, mini computers, mainframe computers, Field Programmable Gate Arrays (FPGAs) and the like. The embodiments can be embodied in a special purpose computer or data processor that is specifically programmed configured or constructed to perform one or more of the computer executable mechanisms explained in detail below.

Exemplary embodiments now will be described with reference to the accompanying drawings. The disclosure may, however, be embodied in many different forms and should not be construed as limited to the embodiments set forth herein; rather, these embodiments are provided so that this disclosure will be thorough and complete, and will fully convey its scope to those skilled in the art. The terminology used in the detailed description of the particular exemplary embodiments illustrated in the accompanying drawings is not intended to be limiting. In the drawings, like numbers refer to like elements.

The specification may refer to “an”, “one” or “some” embodiment(s) in several locations. This does not necessarily imply that each such reference is to the same embodiment(s), or that the feature only applies to a single embodiment. Single features of different embodiments may also be combined to provide other embodiments:

As used herein, the singular forms “a”, “an” and “the” are intended to include the plural forms as well, unless expressly stated otherwise. It will be further understood that the terms “includes”, “comprises”, “including” and/or “comprising” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations and arrangements of one or more of the associated listed items.

Unless otherwise defined, all terms (including technical and scientific terms) used herein have the same meaning as commonly understood by one of ordinary skill in the art to which this disclosure pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The figures depict a simplified structure only showing some elements and functional entities, all being logical units whose implementation may differ from what is shown. The connections shown are logical connections; the actual physical connections may be different. It is apparent to a person skilled in the art that the structure may also comprise other functions and structures. It should be appreciated that the functions, structures, elements and the protocols used in communication are irrelevant to the present disclosure. Therefore, they need not be discussed in more detail here.

In addition, all logical units described and depicted in the figures include the software and/or hardware components required for the unit to function. Further, each unit may comprise within itself one or more components, which are implicitly understood. These components may be operatively coupled to each other and be configured to communicate with each other to perform the function of the said unit.

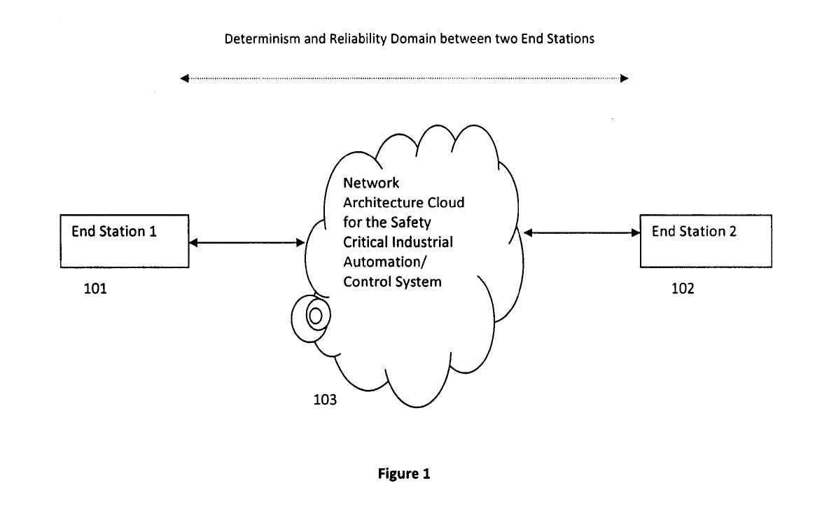

FIG. 1 illustrates prior art block diagram of a system in accordance with an embodiment of the invention. As shown, there are two end stations 101, 102 and a network domain wherein determinism and reliability parameters are measured in a safety critical network. A network architecture cloud 103 for the Safety Critical Industrial Automation or Control System is established between the two end stations to measure the parameters quantitatively, in order to ensure determinism and reliability.

The present invention disclosure discloses a real-time deterministic unit that shall be distributed across Ethernet network interface of sending end station, all Ethernet switches in network and Ethernet network interface of receiving end station and shall be responsible for taking corrective actions to ensure that determinism and reliability objectives are met at all times when the network is operating.

The real-time, distributed, deterministic unit is described in the following paragraphs. An on-line measurement of below given parameters is conducted on all Ethernet virtual connections (EVCs) that are carrying data traffic to meet determinism and reliability objectives: End-to-end latency, Latency of each hop, End-to-end Jitter, Jitter of each hop, End-to-end Frame error rate, Frame error rate of each hop, End-to-end Frame loss rate, Frame loss rate of each hop, Latency at each layer of protocol stack in Sending end Station, Latency at each layer of protocol stack in Receiving end Station.

According to an embodiment, it is determined if all the aforementioned parameters are within an inner threshold or if a certain parameter has crossed the inner threshold. Inner threshold refers to a value within the upper bound with the objective that corrective action can be initiated when measured values cross inner threshold and the corrective action is completed before outer thresholds are crossed. It is assumed that network has been engineered in a way that quantitative values for parameters such as maximum latency, jitter, frame loss and frame errors can be attributed to each hop of the network and for each layer of protocol in sending and receiving end station to meet the overall determinism and reliability goals and a threshold (optionally called as outer threshold) is defined for the upper bound of the same.

Subsequently, communication with nearby instances of deterministic unit and processing is done to find root cause of exceeding of inner thresholds. According to an embodiment, various actions are undertaken to control determinism and reliability in the network. These actions may include performing one or more of the following: provisioning additional buffers, increasing priority of selective EVCs, modifying properties of traffic shaper of Ethernet Interface of Sending End Station, modifying properties of traffic shaper of egress interface of an Intermediate Switch, modifying Scheduler parameters of EVCs at Ethernet Interface of Sending End Station, modifying scheduler parameters of EVCs at an Intermediate Switch, prioritizing or modifying queues or buffers in the protocol stack at sending end station or receiving end station. Further actions include using an alternate EVC that has been pre-configured through an independent and mutually exclusive set of switch path, as a part of redundancy between sending and receiving end station, between the sending end station and receiving end station.

According to a preferred embodiment, the above steps are re-iterated until all measured parameters fall within their respective inner thresholds.

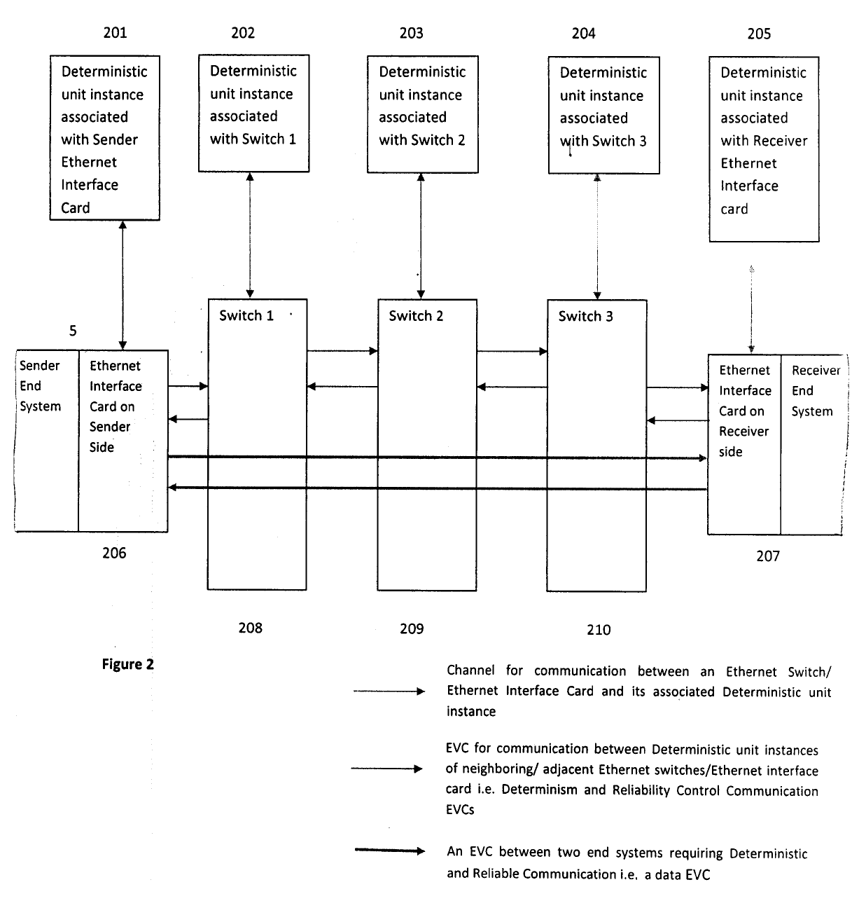

FIG. 2 illustrates a block diagram of the system according to an embodiment of the present disclosure. As shown in the figure, all switches, switch 208, switch 209, switch 210 in the network shall compute determinism and reliability parameters of all EVCs passing through it and send information to the deterministic unit instance associated with it. The system may optionally be a multi-core system where one or more cores perform functions of Ethernet switch and there are one or more dedicated cores which run the deterministic unit logic. In such a scenario, communication between the core/s having the function of Ethernet Switch and the core/s having the function of deterministic unit, is through inter-core communication mechanism.

Dedicated EVC connections may be set up between neighboring switches so as to enable communication between deterministic unit instances 201, 202, 203, 204, 205 associated with different switches. These EVC connections are optionally called determinism and reliability controlling EVCs. Although these. EVCs physically connect neighboring switches, however, since they are dedicated EVCs for communication between adjacent deterministic units, hence these EVCs are considered to be virtually connecting the deterministic units directly.

According to a further embodiment, all occurrences of deterministic units shall be pre-programmed with inner and outer thresholds of all data EVCs. Data EVCs are those EVCs which are not deterministic control EVCs and are actually those which carry information whose determinism and latency has to be ensured, passing through a switch. Deterministic unit instance(s) associated with one or more switches or Ethernet Network Interface Card that have been identified to be the root cause of determinism and reliability parameters exceeding the inner threshold, takes corrective action. The steps of on-line measurement of determinism and reliability parameters of data EVCs, exchange of these parameters with neighbors through determinism and reliability controlling EVCs and taking corrective action are continued until the parameters are brought in control i.e. within the inner threshold bounds. In the figure; different types of connections are shown differently (with different color codes). For instance, a channel for communication between an Ethernet Switch or Ethernet Interface Card and its associated Deterministic unit instance is shown differently. A second type of connection is EVC for communication between Deterministic unit instances of neighboring/adjacent Ethernet switches/Ethernet interface card i.e. Determinism and Reliability Control Communication EVCs. Third kind of connection shown in FIG. 2 is for an EVC between two end systems 206, 207 requiring Deterministic and Reliable Communication i.e. a data EVC.

The present invention disclosure has the following advantages. This invention has the capability to control determinism and reliability parameters of data EVCs at all times in a safety critical network that has been designed with best practices to meet determinism and reliability objectives. Running deterministic unit on a processor-memory unit or a core that is different from the Ethernet Switch or Ethernet Network Interface Card (NIC) shall ensure that the processing performance on the Ethernet Switch or NIC that is doing processing of data EVCs shall not get affected.

The abovementioned description of the embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

As will be appreciated by one skilled in the art, the present invention may be embodied as a method, system, or computer program product. Accordingly, the present invention may take the form of an entirely hardware embodiment, a software embodiment or an embodiment combining software and hardware aspects all generally referred to herein as a “circuit” or “module.” Furthermore, the present invention may take the form of a computer program product on a computer-usable storage medium having computer-usable program code embodied in the medium.

It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

Instructions may also be loaded onto a computer or other programmable data processing apparatus like a scanner/check scanner to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

In the drawings and specification, there have been disclosed exemplary embodiments of the invention. Although specific terms are employed, they are used in a generic and descriptive sense only and not for purposes of limitation, the scope of the invention being defined by the following claims.

We claim:

1. A method for monitoring deterministic characteristics of a safety critical network, said method comprising:
determining a plurality of parameters on an Ethernet virtual connection (EVC);
detecting the parameters that exceed an inner threshold;
communicating the outcome of detected parameters to an associated deterministic unit such that the specific parameter is controlled.

2. The method as claimed in claim 1, wherein said plurality of parameters comprise at least end-to-end latency, Latency of each hop, end-to-end Jitter, Jitter of each hop, End-to-end Frame error rate, Frame error rate of each hop, End-to-end Frame loss rate, Frame loss rate of each hop, Latency at each layer of protocol stack in Sending end Station, Latency at each layer of protocol stack in Receiving end Station.

3. The method as claimed in claim 1, wherein the inner threshold comprises an outcome exceeding which control is initiated.

4. The method as claimed in claim 1, wherein the parameters of said EVC are determined by an Ethernet switch associated to the deterministic unit.

5. The method as claimed in claim 1, wherein the step of detection comprises an outer threshold.

6. The method as claimed in claim 5, wherein the outer threshold comprises an outcome before which the control is completed.

7. A system for monitoring deterministic characteristics of a safety critical network, said system comprising:
an Ethernet switch associated with a processor-memory unit;
a communication channel between the Ethernet switch and the processor-memory unit associated with it which runs the deterministic unit functionality; and
an Ethernet virtual connection (EVC) between adjacent switches through which the associated deterministic units communicate with each other.

8. The system as claimed in claim 7, wherein a multi core system with one or more cores running Ethernet switch functionality and one or more dedicated cores running deterministic unit functionality.

9. The system as claimed in claim 7, wherein the Ethernet switch is a router.

10. The system as claimed in claim 7, wherein the Ethernet switch is an Ethernet interface card of a sender end station.

11. The system as claimed in claim 7, wherein the Ethernet switch is an Ethernet interface card of a receiver end station.

12. The system as claimed in claim 8, wherein the Ethernet switch is a router.

13. The system as claimed in claim 8, wherein the Ethernet switch is an Ethernet interface card of a sender end station.

14. The system as claimed in claim 8, wherein the Ethernet switch is an Ethernet interface card of a receiver end station.
